(19) United States
(12) Patent Application Publication
(10) Pub. No.: US 2013/0277354 A1
(43) Pub. Date: Oct. 24, 2013

(54) METHOD AND APPARATUS FOR PLASMA HEAT TREATMENT

(71) Applicants: Masatoshi Miyake, Kamakura (JP); Ken'etsu Yokogawa, Tsurugashima (JP); Takashi Uemura, Kudamatsu (JP); Masaru Izawa, Hino (JP); Satoshi Sakai, Yokohama (JP)

(72) Inventors: Masatoshi Miyake, Kamakura (JP); Ken'etsu Yokogawa, Tsurugashima (JP); Takashi Uemura, Kudamatsu (JP); Masaru Izawa, Hino (JP); Satoshi Sakai, Yokohama (JP)

(73) Assignee: Hitachi High-Technologies Corporation

(21) Appl. No.: 13/571,730

(22) Filed: Aug. 10, 2012

(30) Foreign Application Priority Data
Apr. 18, 2012 (JP) 2012-094474

(51) Int. Cl. H05H 1/48

(52) U.S. Cl. 219/383

(57) ABSTRACT

There is provided a method for plasma heat treatment that can suppress the degradation of thermal efficiency even in the case where plasma is used to heat a sample at a temperature of 1,200° C. or more. In a method for plasma heat treatment that a sample to be processed is heated by plasma, the method including the steps of: preheating in which a heat treatment chamber is exhausted while preheating an upper electrode and a lower electrode using plasma generated between the upper electrode and the lower electrode; and heat treatment in which the sample to be processed is heated after the preheating step. The upper electrode and the lower electrode are electrodes containing carbon.

### CLAIM OF PRIORITY

The present application claims priority from Japanese Patent Application JP 2012-094474 filed on Apr. 18, 2012, the content of which is hereby incorporated by reference into this application.

### BACKGROUND OF THE INVENTION

1. Field of the Invention

The present invention relates to a method and apparatus for plasma heat treatment.

2. Description of the Related Arts

In these years, it is expected to introduce a new material having a wide band gap such as silicon carbide (SiC) as a substrate material for a power semiconductor device. SiC that is a wide band gap semiconductor has excellent physical properties such as a high dielectric breakdown field, high saturation electron velocity, and a high thermal conductivity coefficient more than those of silicon (Si). Since SiC is a high dielectric breakdown field material, SiC enables a thinner film device, high concentration doping, and the manufacture of a device of a high withstand voltage and a low resistance. Moreover, Sic can suppress thermally excited electrons because of a large band gap, and SiC enables a stable operation at high temperature because SiC has a high heat dissipation performance due to a high thermal conductivity coefficient. Therefore, it is expected that the implementation of a SiC power semiconductor device will enable a significant improvement and higher performance of electric power such as power transportation and power conversion and of various electric power devices such as industrial power devices and home appliances.

The process steps of manufacturing various power devices using SiC for substrates are almost similar to the case where Si is used for substrates. However, a heat treatment process step is taken as a considerably different process step. A representative heat treatment process step is annealing for activation that is performed after the ion implantation of an impurity for the purpose of conductivity control of a substrate. In the case of an Si device, annealing for activation is performed at temperatures of 800 to 1,200° C. On the other hand, in the case of an SiC device, temperatures of 1,200 to 2,000° C. are necessary because of the material characteristics of SiC.

For an annealing apparatus intended for SiC, Japanese Patent Application Laid-Open Publication No. 2012-059872 discloses an apparatus that heats a wafer with atmospheric pressure plasma generated by radio frequency.

### SUMMARY OF THE INVENTION

It is expected that the apparatus described in Japanese Patent Application Laid-Open Publication No. 2012-059872 will enable the improvement of thermal efficiency, the improvement of heating response, and a reduction in the costs of consumable items for oven members as compared with a conventional resistance heating oven. Therefore, a heat treatment apparatus using this atmospheric pressure plasma was studied from the viewpoint of a long-term stability. As a result, in the case where heating is performed at a temperature of 1,200° C. or more according to a method for heating a wafer using atmospheric pressure plasma, it was revealed that the following problem arises from the viewpoint of a long-term stability.

The annealing apparatus disclosed in Japanese Patent Application Laid-Open Publication No. 2012-059872 performs heating using atmospheric pressure plasma generated between parallel plate electrodes with radio frequency. Although a graphite electrode is used in order to withstand high temperature treatment, a foreign substance having carbon as a principal component (in the following, referred to as soot) is generated when impurity gas other than He is included in a heating chamber. When the generated soot is attached to the surface of a reflecting mirror provided for the purpose of heating efficiency improvement, it is likely to degrade thermal efficiency such as a reduction in the reproducibility of processing temperature and an increase in electric power necessary for implementing a desired temperature due to a reduction in the reflectance for the long term.

It is an object of the present invention to provide a method and apparatus for plasma heat treatment that can suppress the degradation of thermal efficiency even in the case where plasma is used to heat a sample at a temperature of 1,200° C. or more.

An embodiment for achieving the object is a method for plasma heat treatment using an apparatus for plasma heat treatment including a heat treatment chamber in which plasma generated between an upper electrode and a lower electrode heats a samle to be processed. The method includes the steps of: preheating in which the heat treatment chamber is exhausted while preheating the upper electrode and the lower electrode using plasma generated between the upper electrode and the lower electrode; and heat treatment in which the sample to be processed is heated after the preheating step. The upper electrode and the lower electrode are electrodes containing carbon.

Moreover, an embodiment for achieving the object is an apparatus for plasma heat treatment including: a heat treatment chamber; a reflecting mirror disposed in the heat treatment chamber; a graphite upper electrode and a graphite lower electrode disposed on an inner side of the reflecting mirror; a sample stage disposed below the lower electrode and configured to hold a sample to be processed; a radio frequency power supply configured to generate plasma between the upper electrode and the lower electrode; a gas introducing unit configured to introduce gas between the upper electrode and the lower electrode; an exhausting unit configured to exhaust the heat treatment chamber; and a preheating function to exhaust the heat treatment chamber while preheating the upper electrode and the lower electrode using plasma generated between the upper electrode and the lower electrode before heating the sample to be processed.

According to the present invention, it is possible to provide a method and apparatus for plasma heat treatment that can suppress the degradation of thermal efficiency even in the case where plasma is used to heat a sample at a temperature of 1,200° C. or more.

### BRIEF DESCRIPTION OF THE INVENTION

The present invention will become fully understood from the detailed description given hereinafter and the accompanying drawings, wherein:

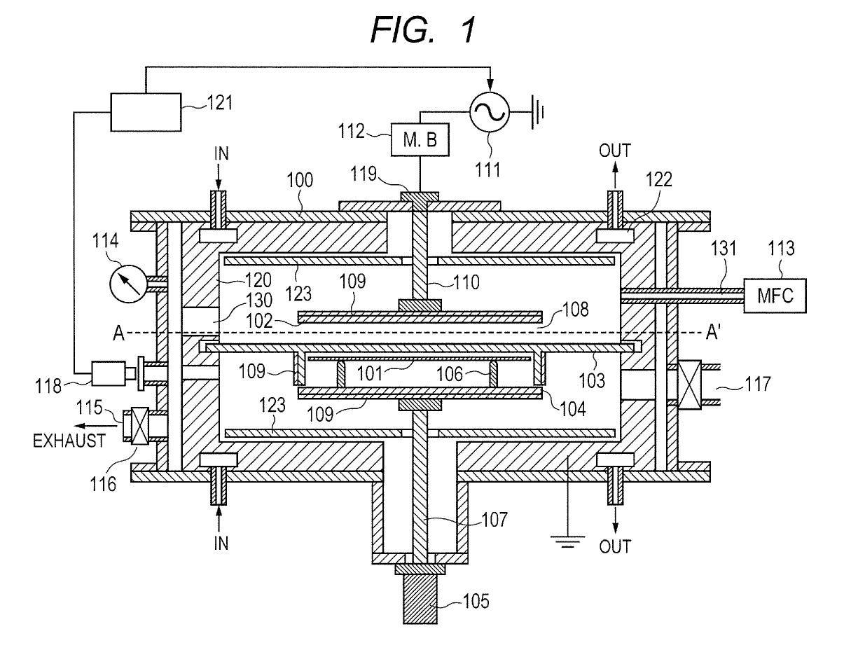

FIG. 1 is a basic block diagram of a plasma heat treatment apparatus according to a first embodiment of the present invention;

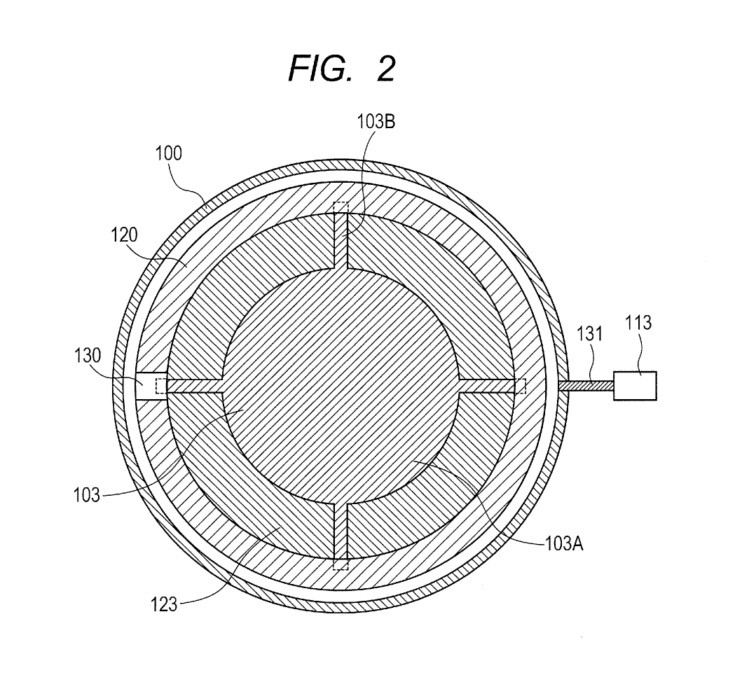

FIG. 2 is a top view seen from cross section A-A′ of a heat treatment chamber of the plasma heat treatment apparatus illustrated in FIG. 1;

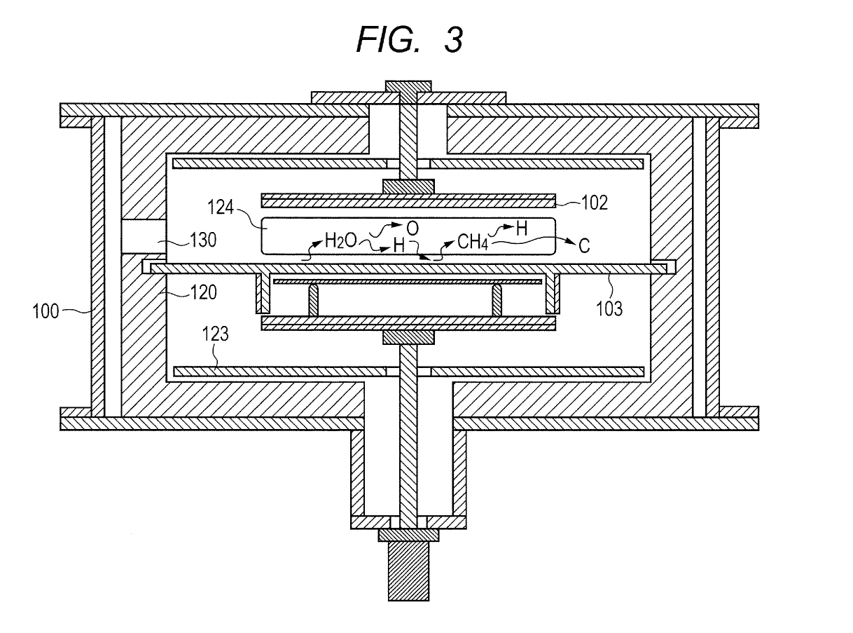

FIG. 3 is a schematic diagram for describing a mechanism of generating soot in the plasma heat treatment apparatus according to the first embodiment of the present invention;

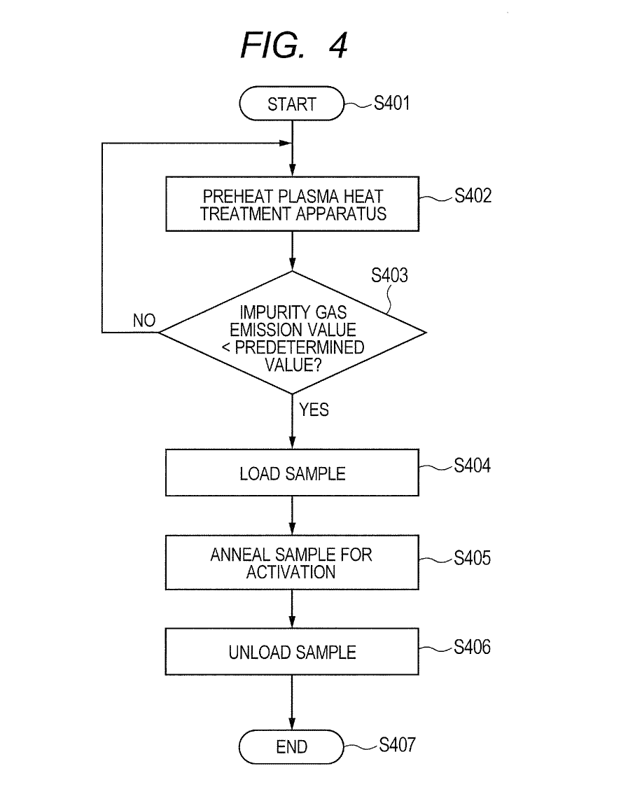

FIG. 4 is a flowchart for describing a plasma heat treatment method according to the first embodiment of the present invention;

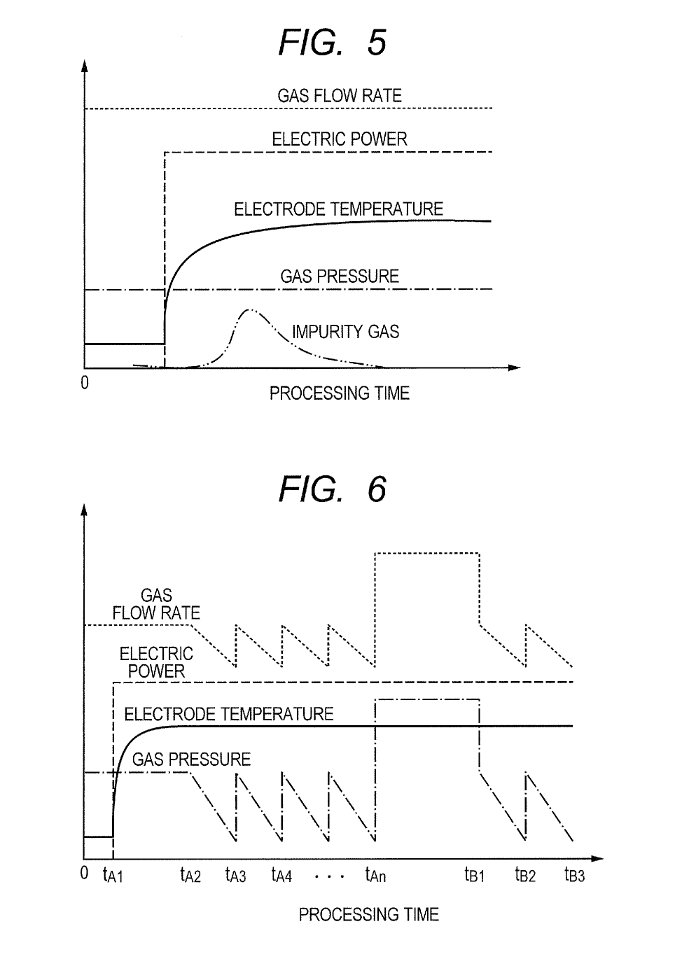

FIG. 5 is a process sequence for describing a preheating process for a graphite electrode in a plasma heat treatment method according to the first embodiment of the present invention; and

FIG. 6 is a process sequence for describing the process step of preheating a graphite electrode in a plasma heat treatment method according to a second embodiment of the present invention.

### DETAILED DESCRIPTION OF THE PREFERRED EMBODIMENTS

Since a processing chamber is sealed in a plasma heat treatment apparatus during heat treatment from the viewpoint of thermal efficiency improvement, and since a trace amount of an atmospheric gas is fed even in the case of feeding the atmospheric gas, it can be considered that when soot or the like is generated, the soot is filled in the processing chamber and attached to the inner wall. Therefore, the present inventors performed heat treatment for a long time where the processing chamber was sealed on the presence or absence of soot or the like. As a result, it was confirmed that a trace amount of soot was attached to a reflecting mirror. The present inventors thought that some measures were necessary against still a trace amount of soot from the viewpoint of a long-term stability, and investigated the cause. As a result, it was estimated that a main cause of generating soot is a gas (H₂, H₂O, and the like) absorbed in a graphite electrode. Namely, it is considered that these gases are coupled to graphite to form methane for generating a carbon cluster in plasma, the carbon cluster floats in the processing chamber in a sealed state or in a nearly sealed state (the gas flow rate is a trace amount) for high temperature treatment, and soot is attached in the inside of the processing chamber including the reflecting mirror. The present invention is made based on the findings in a configuration in which graphite electrodes are preheated using plasma before heating a sample at high temperature, gas absorbed in the graphite electrodes is removed beforehand, and high temperature heat treatment is enabled without exposing the graphite electrodes to an atmosphere after this processing. Thus, it is possible to provide a plasma heat treatment method that can suppress the degradation of thermal efficiency and a plasma heat treatment apparatus excellent in the reproducibility of processing temperature even in the case where a sample is heated at a temperature of 1,200° C. or more. It is noted that preferably, the graphite electrodes are preheated under a low gas pressure where electric discharge is relatively stable as compared with under an atmospheric pressure and an absorbed gas emitted from the graphite electrodes is discharged out of the plasma heat treatment apparatus.

In the following, a method and an apparatus will be described in more detail with reference to embodiments.

### First Embodiment

A first embodiment of the present invention will be described with reference to FIGS. 1 to 5. FIG. 1 is a basic block diagram of a plasma heat treatment apparatus according to this embodiment. The plasma heat treatment apparatus includes a heat treatment chamber 100 having an upper electrode 102 and a lower electrode 103 in which a sample (a sample to be processed) 101 is indirectly heated with the lower electrode 103 heated using plasma generated between the upper electrode 102 and the lower electrode 103.

The heat treatment chamber 100 includes the upper electrode 102, the lower electrode 103 that is a heating plate disposed as facing the upper electrode 102, a sample stage 104 having a support pin 106 that supports the sample 101, a reflecting mirror 120 that reflects radiant heat, a radio frequency power supply 111 that supplies radio frequency power for generating plasma to the upper electrode 102, a gas introducing unit 113 that supplies gas into the heat treatment chamber 100, and a vacuum valve 116 that adjusts a pressure in the heat treatment chamber 100. A numeral 117 denotes a loading port for the sample. It is noted that the same reference numerals and signs indicate the same components in the drawings.

The sample 101 is supported on the support pin 106 of the sample stage 104 and near the bottom side of the lower electrode 103. Moreover, the lower electrode 103 is held by the reflecting mirror 120, and does not contact with the sample 101 and the sample stage 104. In this embodiment, a four-inch SiC substrate (a diameter of 100 mm) is used for the sample 101. The diameter and thickness of the upper electrode 102 and the sample stage 104 are 120 mm and 5 mm, respectively.

The lower electrode will be described with reference to FIG. 2. FIG. 2 illustrates a top view of cross section A-A′ in FIG. 1. The lower electrode 103 includes a disk-shaped member 103A having the same diameter as the diameter of the upper electrode 102 and four beams 103B disposed at regular intervals and connecting the disk-shaped member 103A to the reflecting mirror 120. The thickness of the lower electrode 103 is 2 mm. It is sufficient that the number of the beams 103B and the cross sectional area and thickness of the beam 1038 are determined in consideration of the strength of the lower electrode 103 and heat dissipation from the lower electrode 103 to the reflecting mirror 120. Moreover, the lower electrode 103 has a member having a cylindrical inner shape that covers the side surface of the sample 101, and the member is disposed on the opposite side of the surface facing the upper electrode 102.

Since the lower electrode 103 has a structure having the beams as illustrated in FIG. 2, the lower electrode 103 can suppress the transfer of the heat of the lower electrode 103 heated by plasma to the reflecting mirror 120, so that the lower electrode 103 functions as a heating plate of a high thermal efficiency. It is noted that plasma generated between the upper electrode 102 and the lower electrode 103 is diffused from a space between the beams to the vacuum valve 116 side. However, since the sample 101 is covered with the member in a cylindrical inner shape, the sample 101 is not exposed to plasma.

Moreover, for the upper electrode 102, the lower electrode 103, the sample stage 104, and the support pin 106, such components are used that SiC is deposited on the surface of a graphite base material by chemical vapor deposition (in the following, referred to as CVD).

Furthermore, a gap 108 between the lower electrode 103 and the upper electrode 102 is 0.8 mm. It is noted that the sample 101 has a thickness of about 0.5 to 0.8 mm, and the circumferential corners of the upper electrode 102 and the lower electrode 103 facing each other are tapered or rounded. The tapered or rounded corners are provided to suppress localized plasma at the corners of the upper electrode 102 and the lower electrode 103 due to the concentration of electric fields.

The sample stage 104 is connected to an ascending and descending mechanism 105 through a shaft 107, and the ascending and descending mechanism 105 is operated to enable the loading and unloading of the sample 101 and the sample 101 to be brought close to the lower electrode 103. The detail will be described later. Moreover, an alumina material is used for the shaft 107.

Radio frequency power from the radio frequency power supply 111 is supplied to the upper electrode 102 through an upper power supply line 110. In this embodiment, a frequency of 13.56 MHz is used for the frequency of the radio frequency power supply 111. The lower electrode 103 is conducted to the reflecting mirror 120 through the beams. Moreover, the lower electrode 103 is grounded through the reflecting mirror 120. The upper power supply line 110 is also made of graphite that is the material of forming the upper electrode 102 and the lower electrode 103.

A matching circuit 112 (it is noted that M.B in FIG. 1 is the abbreviation of a Matching Box) is disposed between the radio frequency power supply 111 and the upper electrode 102, in which radio frequency power from the radio frequency power supply 111 is efficiently supplied to plasma formed between the upper electrode 102 and the lower electrode 103.

The upper electrode 102, the lower electrode 103, and the sample stage 104 in the heat treatment chamber 100 are structured to be surrounded by the reflecting mirror 120. The reflecting mirror 120 is formed, in which the inner wall surface of a metal base material is optically polished and gold is plated or vapor deposited on the polished surface. Moreover, a coolant passage 122 is formed in the metal base material of the reflecting mirror 120, in which cooling water is fed to keep the temperature of the reflecting mirror 120 constant. Since the reflecting mirror 120 is provided to reflect radiant heat from the upper electrode 102, the lower electrode 103, and the sample stage 104, thermal efficiency can be enhanced. However, the reflecting mirror 120 is not always a necessary configuration for the present invention.

Moreover, a protection silica plate 123 is disposed between the upper electrode 102 and the reflecting mirror 120 and between the sample stage 104 and the reflecting mirror 120. The protection silica plate 123 has a function to prevent substances (graphite sublimation or the like) emitted from the upper electrode 102, the lower electrode 103, and the sample stage 104 that go to a high temperature of 1,200° C. or more from contaminating the surface of the reflecting mirror 120 and a function to prevent contamination possibly mixed from the reflecting mirror 120 into the sample 101.

The inside of the heat treatment chamber 100 in which the upper electrode 102 and the lower electrode 103 are disposed is structured such that the gas introducing unit 113 and a gas introducing nozzle 131 can introduce gas up to at a pressure of 10 atmospheres. The pressure of gas to be introduced is monitored by a pressure detecting unit 114. Moreover, the heat treatment chamber 100 can exhaust gas by a vacuum pump connected to an air outlet port 115 and a vacuum valve 116. Desirably, the tip end of the gas introducing nozzle 131 is disposed at the height between the upper electrode 102 and the lower electrode 103. The tip end of the gas introducing nozzle 131 has a tapered shape which enables gas to be powerfully blown between the electrodes. The position of the gas introducing nozzle 131 is variable, and processing is performed, during preheating, in which the gas introducing nozzle 131 is brought close to the side surface of the upper electrode 102 at a distance of 10 mm. In this processing, desirably, an insulator is used for the gas introducing nozzle 131 in order to avoid electric discharge between the upper electrode 102 and the gas introducing nozzle 131. In this embodiment, alumina is used for the gas introducing nozzle 131. Furthermore, an internal air outlet port 130 is provided at the height between the upper electrode 102 and the lower electrode 103, and the conductance from the space between the upper and lower electrodes to the internal air outlet port 130 is reduced to efficiently exhaust gas between the electrodes. Thus, soot emitted from the electrodes is also quickly discharged as no soot dwells in the heat treatment chamber.

As illustrated in FIG. 1, a plate material 109 having a high melting point and low emissivity or a coating 109 having a high melting point and low emissivity is provided on the surface opposite the surface of the upper electrode 102 contacting with plasma, on the outer surface of the member in a cylindrical inner shape covering the side surfaces of the lower electrode 103 and the sample 101, and on the lower surface of the sample stage 104. Since the plate material 109 having the high melting point and low emissivity or the coating 109 having the high melting point and low emissivity is provided to reduce radiant heat from the upper electrode 102, the lower electrode 103, and the sample stage 104, thermal efficiency can be enhanced.

It is noted that in the case where the processing temperature is low, these components are not necessarily provided. In the case of high temperature treatment, any one of the plate material 109 having the high melting point and low emissivity, the coating 109 having the high melting point and low emissivity, and the reflecting mirror 120 is provided or both of the plate material 109 having the high melting point and low emissivity or the coating 109 having the high melting point and low emissivity and the reflecting mirror 120 are provided to perform heating at a predetermined temperature. The temperature of the lower electrode 103 or the sample stage 104 is measured by a radiation thermometer 118. In this embodiment, a plate material having a graphite base material coated with TaC (tantalum carbide) is used for the plate material 109 having the high melting point and low emissivity or the coating 109 having the high melting point and low emissivity applied to the upper electrode 102, the lower electrode 103, and the sample stage 104. Moreover, the gas introducing nozzle 131 is disposed above the beams of the lower electrode 103 to suppress the flow of the introduced gas going to the lower side of the lower electrode 103 and to efficiently feed gas between the upper electrode 102 and the lower electrode 103. It is noted that the internal air outlet port 130 is disposed at a position facing the gas introducing nozzle 131 to facilitate the exchange of gas between the upper and lower electrodes.

Next, the mechanism of assuming the generation of soot that reduces the reproducibility of heat treatment will be described with reference to FIG. 3. The replacement of the graphite electrodes and consumable parts, cleaning the inside of the processing chamber, or the like causes the graphite electrodes and the surface of the heating chamber to be exposed to an atmosphere, and the graphite electrodes and the surface of the heating chamber absorb moisture (H₂O) in the atmosphere. When the graphite electrodes 102 and 103 and the side walls of the heating chamber are heated with plasma 124, the absorbed moisture is released in a gaseous phase. When this moisture (H₂O) is decomposed by plasma, a hydrogen atom (H) and an oxygen atom (O) are generated. The hydrogen atom activated in plasma is coupled to carbon (C) on the surface of the graphite electrode, and released into the gaseous phase as a hydrocarbon compound (CH₄, for example). This hydrocarbon compound is decomposed into carbon (C) and hydrogen (H) in plasma. The gas flow rate is presently basically zero during heat treatment in order to enhance heating efficiency, the generated carbon (C) is coupled to the generated carbon (C) to form soot. Moreover, since hydrogen (H) remains in the heating chamber without exhausting hydrogen (H), hydrogen (H) again repeatedly reacts with the graphite electrode to be a hydrocarbon gas.

FIG. 4 illustrates a flowchart of plasma heat treatment. After processing is started (S401), first, the plasma heat treatment apparatus is preheated as described in this embodiment (S402), and impurity gas (gas other than He, such as moisture) absorbed in the graphite electrode, the inner wall of the heating chamber, or the like is removed and exhausted. An impurity gas emission value obtained by measurement is compared with a predetermined value (S403). In the case where the impurity gas is continuously emitted (NO in S403), the plasma heat treatment apparatus is kept preheated until the impurity gas is reduced to a predetermined value. In the case where the impurity gas is reduced to a predetermined value or less (YES in S403), preheating is finished, and a preheated sample is loaded into the plasma heat treatment apparatus (S404). After loading the sample, high temperature heat treatment for activating the sample (annealing for activation) is performed (S405), the sample is unloaded (S406), and the processing is ended (S407). It is noted that glow discharge plasma is used for preheating in Step S402. For the temperature of preheating, temperatures of 700 to 1,000° C. can be used. In preheating, it is sufficient that the temperature is set at a predetermined temperature or more; the temperature may be controlled constantly, or input power may be controlled constantly. Moreover, in high temperature heat treatment in Step 405, the heat treatment chamber is set in the sealed state, or in a nearly sealed state (the gas flow rate is at a trace amount). However, in the case of heat treatment at a temperature of 1,200° C. or less, the heat treatment chamber is not necessarily set in the sealed state. In this embodiment, an example is described in which the preheated sample is subjected to plasma heat treatment. However, such a configuration may be possible in which a sample that is not preheated is loaded into the plasma heat treatment apparatus and the sample is preheated in the plasma heat treatment apparatus. Alternatively, the sample may not be preheated and subjected to plasma heat treatment. Moreover, in the description above, the graphite electrodes are preheated with plasma, and then the sample is loaded into the plasma heat treatment apparatus. However, in the case where it is expected that an amount of gas absorbed in the graphite electrodes will be small, the sample may be loaded into the plasma heat treatment apparatus before preheating the graphite electrodes with plasma.

Next, an exemplary basic operation of the preheating process for the graphite electrodes (S402) performed before heating the sample 101 at a high temperature of 1,200° C. or more will be described with reference to FIGS. 1 and 5. First, He gas in the heat treatment chamber 100 is exhausted from the air outlet port 115 to provide a high vacuum state. In the stage in which the gas exhaust is sufficiently finished, gas is introduced from the gas introducing unit 113, and the inside of the heat treatment chamber 100 is controlled at a pressure of 0.1 atmosphere (a control unit is not illustrated). It is noted that the gas is not completely sealed and the gas introducing unit 113 and the gas introducing nozzle 131 feed gas at a large flow rate while exhausting the gas from the air outlet port 115. Thus, a gas flow can be generated between the upper electrode 102 and the lower electrode 103, and the gas in the heat treatment chamber 100 can be efficiently exchanged simultaneously. In this embodiment, He is used for gas introduced into the heat treatment chamber 100. At a point in time when a gas pressure in the heat treatment chamber 100 is stabilized, radio frequency power from the radio frequency power supply 111 is supplied to the upper electrode 102 through the matching circuit 112 and a power introducing terminal 119, and plasma is generated in the gap 108 to heat the upper electrode 102 and the lower electrode 103. The energy of the radio frequency power is absorbed in electrons in plasma, and the electrons collide with each other to heat the atoms or molecules of a raw material gas. Moreover, ions generated by ionization are accelerated by a potential difference generated in a sheath between the surfaces of the upper electrode 102 and the lower electrode 103 contacting with plasma, and the ions enter the upper electrode 102 and the lower electrode 103 while colliding with the raw material gas. In this collision process, the temperature of gas filled between the upper electrode 102 and the lower electrode 103 and the temperature of the surfaces of the upper electrode 102 and the lower electrode 103 can be increased.

Particularly near an atmospheric pressure like this embodiment, it can be considered that the raw material gas filled between the upper electrode 102 and the lower electrode 103 can be efficiently heated because ions frequently collide with the raw material gas when the ions pass through the sheath. As a result, the temperature of the electrodes is increased. When the temperature of the electrodes is increased, a loss due to thermal radiation or the like is increased, heat input to the electrodes is soon balanced with a heat loss from the electrodes, and the temperature of the electrodes becomes almost saturated. The main object of this embodiment is to preheat the electrodes, and the temperature of the electrodes is set to reach a temperature of 1,000° C. With an increase in the temperature of the electrodes, gas absorbed in the electrodes is removed from the electrodes. Moreover, in this embodiment, although graphite is used as a material for the electrodes, a hydrogen gas occluded in graphite is released at a peak temperature of 700° C. Therefore, the temperature of the electrodes is set at a temperature of 1,000° C., and it is possible to remove gas absorbed in the electrodes, hydrogen gas occluded in graphite, and hydrocarbon gas including methane (see impurity gas in FIG. 5). It is noted that when impurity gas released from the electrodes is kept remaining between the upper electrode 102 and the lower electrode 103, the remaining impurity gas causes unstable electric discharge and the generation of soot. In this embodiment, since the gas introducing nozzle 131 and the internal air outlet port 130 positively exchange gas between the electrodes with He gas, the impurity gas is discharged from the gap between the upper electrode 102 and the lower electrode 103, and electric discharge will not become unstable.

As described above, in preheating the upper electrode and the lower electrode using plasma, it is possible to remove impurity gas absorbed or occluded in the electrodes without causing unstable electric discharge and the generation of soot.

The temperature of the lower electrode 103 or the sample stage 104 in heating the sample is measured by the radiation thermometer 118, and a controller 121 controls the output of the radio frequency power supply 111 so as to be a predetermined temperature using this measured value. Thus, the temperature of the sample 101 can be highly accurately controlled. In this embodiment, the inputted radio frequency power is 20 kW at the maximum.

In order to efficiently increase the temperature of the upper electrode 102, the lower electrode 103, and the sample stage 104 (including the sample 101), it is necessary to suppress heat transfer from the upper power supply line 110, heat transfer through He gas atmosphere, and radiation from a high temperature region (from an infrared region to a visible light region). Particularly in a high temperature state, the influence of heat dissipation due to radiation is considerably large, and a reduction in a radiation loss is necessary to improve heating efficiency. It is noted that the radiation value of a radiation loss is increased in proportion to the fourth power of the absolute temperature.

As described above, in this embodiment, in order to suppress a radiation loss, the plate material 109 having the high melting point and low emissivity or the coating 109 having the high melting point and low emissivity is provided on the upper electrode 102, the lower electrode 103, and the sample stage 104. TaC is used for the material of a high melting point and a low emissivity. The emissivity of TaC ranges from about 0.05 to 0.1, and TaC reflects infrared rays in association with radiation at a reflectance of about 90%. Thus, the plate material 109 having the high melting point and low emissivity or the coating 109 having the high melting point and low emissivity suppresses a radiation loss from the upper electrode 102, the lower electrode 103, and the sample stage 104, and the sample 101 can be heated with a high thermal efficiency.

TaC is provided in a state in which TaC is not directly exposed to plasma, and an impurity contained in Ta or TaC is not mixed into the sample 101 during heat treatment. Moreover, since the heat capacity of the plate material 109 having the high melting point and low emissivity or the coating 109 having the high melting point and low emissivity, which is made of TaC, is considerably small, an increase in the heat capacity of the heating unit can be suppressed at the minimum. Thus, there are almost no reductions in the rates of temperature increase and decrease caused by providing the plate material 109 having the high melting point and low emissivity or the coating 109 having the high melting point and a low emissivity.

Furthermore, plasma that is a heating source is plasma in the glow discharge region to form plasma uniformly spread between the upper electrode 102 and the lower electrode 103. The upper electrode 102 and the lower electrode 103 can be uniformly heated using this uniform, flat plasma for a heat source.

In this embodiment, the gap 108 between the upper electrode 102 and the lower electrode 103 is 0.8 mm. However, the similar effect is also exerted as the gap 108 ranges from 0.1 to 2 mm. Although electric discharge is also possible in the case where the gap is narrower than 0.1 mm, a highly accurate function is necessary to maintain the parallelism between the upper electrode 102 and the lower electrode 103. Moreover, the deterioration (roughness or the like) of the surfaces of the upper electrode 102 and the lower electrode 103 affects plasma, so that a narrower gap is not preferable. On the other hand, in the case where the gap 108 exceeds 2 mm, a reduction in the ignitability of plasma and an increase in a radiation loss from the gap become problems, so that a wider gap is not preferable.

In this embodiment, the gas introducing unit 113 and the gas introducing nozzle 131 supply gas, and the tip end of the gas introducing nozzle 131 is directed between the electrodes to generate a gas flow between the upper electrode 102 and the lower electrode 103. However, needless to say, in such a structure in which a hollow is provided in the upper power supply line 110, the plate material 109 having the high melting point and low emissivity or the coating 109 having the high melting point and low emissivity, and the upper electrode 102 and the hollows are used to supply gas to issue the gas from the center part of the upper electrode 102, a gas flow is formed from the center part of the electrodes to the outer circumferential part of the electrodes between the upper electrode 102 and the lower electrode 103 to enable an efficient gas exchange. Moreover, of course, the flow rate of gas to be supplied is increased to raise the gas flow rate, and gas can be exchanged.

In this embodiment, the pressure in the heat treatment chamber 100 to generate plasma is at a pressure of 0.1 atmosphere. However, the similar operation is possible at a pressure of 10 atmospheres or less. Particularly, a gas pressure at pressures of 0.01 to 0.1 atmosphere or less is preferable. When the gas pressure is at a pressure of 0.001 atmosphere or less, the collision frequency of ions in the sheath is reduced to cause ions with a large energy to enter the electrode, and it is likely to sputter the surfaces of the electrodes, for example. Moreover, as assumed in the embodiment, in the case where the gap 108 between the upper electrode 102 and the lower electrode 103 ranges from 0.1 to 2 mm, an electric discharge maintaining voltage is increased when the gas pressure is at a pressure of 0.01 atmosphere or less from Paschen's law, so that this case is not preferable. On the other hand, in the case where the gas pressure is at a pressure of 10 atmospheres or more, a risk to generate faulty electric discharge (unstable plasma and electric discharge at a location other than the location between the upper electrode and the lower electrode) is increased, so that this case is not preferable. In this embodiment, the gas flow rate is changed to control the gas pressure, and the similar effect can be obtained when the gas displacement is changed to adjust the gas pressure. It is noted that of course, it is also possible that the gas flow rate and the gas displacement are simultaneously changed to control a pressure.

In this embodiment, He gas is used for the raw material gas for generating plasma. However, needless to say, the similar effect can be exerted when gas having inert gas such as Ar, Xe, and Kr as a main raw material is used. He gas used in this embodiment is excellent in the ignitability and stability of plasma near an atmospheric pressure. However, the gas thermal conductivity coefficient is high, and a heat loss is relatively large due to heat transfer through the gas atmosphere. On the other hand, since gas with a large mass such as Ar, Xe, and Kr gas has a low thermal conductivity coefficient, these gases are more advantageous than He gas from the viewpoint of thermal efficiency.

In this embodiment, a material that TaC (tantalum carbide) is coated on a graphite base material is used for the plate material 109 having the high melting point and low emissivity or the coating 109 having the high melting point and low emissivity applied on the upper electrode 102, the lower electrode 103, and the sample stage 104. Also, the similar effect can be exerted when WC (tungsten carbide), MoC (molybdenum carbide), Ta (tantalum), Mo (molybdenum), or W (tungsten) is used.

In this embodiment, a graphite base material coated with silicon carbide by CVD is used on the surfaces opposite the surfaces of the upper electrode 102, the lower electrode 103, and the sample stage 104 contacting with plasma. Also, the similar effect can be exerted when a graphite simple substance, a member having graphite coated with pyrolyzed carbon, a member having a graphite surface vitrified, or SiC (a sintered compact, polycrystal, and single crystal) is used. Needless to say, desirably, graphite that is the base material of the upper electrode 102 and the lower electrode 103 and the coating applied to the surfaces of the upper electrode 102 and the lower electrode 103 are highly pure from the viewpoint of preventing contamination to the sample 101.

Moreover, in this embodiment, TaC is used for the plate material 109 having the high melting point and low emissivity or the coating 109 having the high melting point and low emissivity. However, similarly, the similar effect can also be exerted by other materials of a high melting point (a melting point that withstands use temperatures) and a low emissivity. For example, the similar effect can also be exerted by a Ta (tantalum) simple substance, Mo (molybdenum), W (tungsten), WC (tungsten carbide), or the like.

Furthermore, there is also the case where the upper power supply line 110 also contaminates the sample 101 at high temperature. Therefore, in this embodiment, graphite similar to the upper electrode 102 and the lower electrode 103 is used also for the upper power supply line 110. In addition, the heat of the upper electrode 102 is transferred to the upper power supply line 110 to be a loss. Therefore, it is necessary to keep heat transfer from the upper power supply line 110 at the minimum necessary value.

Therefore, it is necessary that the cross sectional area of the upper power supply line 110 made of graphite be made as small as possible and the length be increased. However, when the cross sectional area of the upper power supply line 110 is excessively made small and the length is made longer too much, a radio frequency power loss becomes large in the upper power supply line 110, causing a reduction in heating efficiency of the sample 101. Thus, in this embodiment, from the viewpoints above, the cross sectional area of the upper power supply line 110 made of graphite is 12 mm², and the length is 40 mm. The similar effect can also be obtained in which the cross sectional area of the upper power supply line 110 ranges from 5 to 30 mm², and the length of the upper power supply line 110 ranges from 30 to 100 mm.

Moreover, the heat of the sample stage 104 is transferred to the shaft 107 to be a loss. Therefore, it is necessary to also keep heat transfer from the shaft 107 to the minimum necessary value as similar to the upper power supply line 110 as described above. Therefore, it is necessary that the cross sectional area of the shaft 107 made of an alumina material be made as small as possible and the length be increased. In this embodiment, in consideration of the strength or the like, the cross sectional area and length of the shaft 107 made of an alumina material are the same as those of the upper power supply line 110 described above.

In this embodiment, the plate material 109 having the high melting point and low emissivity or the coating 109 having the high melting point and low emissivity is provided to reduce a radiation loss from the upper electrode 102, the lower electrode 103, and the sample stage 104, and the reflecting mirror 120 returns radiant light to the upper electrode 102, the lower electrode 103, and the sample stage 104 to improve heating efficiency. However, of course, it is expected to improve heating efficiency also in the case where only the plate material 109 having the high melting point and low emissivity or the coating 109 having the high melting point and low emissivity is applied on the upper electrode 102, the lower electrode 103, and the sample stage 104. Similarly, it can be expected to improve heating efficiency also in the case where only the reflecting mirror 120 is provided. Moreover, the protection silica plate 123 is provided to expect the effect of preventing contamination. Sufficient heating efficiency can be obtained without using the protection silica plate 123.

In this embodiment, heat dissipation from the upper electrode 102, the lower electrode 103, and the sample stage 104, which affects heating efficiency as described above, is mainly caused by (1) radiation, (2) heat transfer from the gas atmosphere, and (3) heat transfer from the upper power supply line 110 and the shaft 107. In the case where heat treatment is performed at a temperature of 1,200° C. or more, the main factor of heat dissipation among these causes is (1) radiation. In order to suppress (1) radiation, the plate material 109 having the high melting point and low emissivity or the coating 109 having the high melting point and low emissivity is provided on the surfaces opposite the surfaces of the upper electrode 102, the lower electrode 103, and the sample stage 104 contacting with plasma. Moreover, heat dissipation from the upper power supply line 110 and the shaft 107 in (3) is suppressed at the minimum by optimizing the cross sectional area and length of the upper power supply line 110 and the shaft 107 as described above.

Furthermore, heat transfer from the gas atmosphere in (2) is suppressed by optimizing the heat transfer distance of gas. Here, the heat transfer distance of gas is a distance from the upper electrode 102, the lower electrode 103, and the sample stage 104, which are high temperature units, to the shield (the protection silica plate 123), which is a low temperature unit, or the wall of the heat treatment chamber 100, which is a low temperature unit. In the He gas atmosphere near an atmospheric pressure, since the thermal conductivity coefficient of He gas is high, heat dissipation caused by gas heat transfer becomes relatively high. Therefore, this embodiment has such a structure that the distance from the upper electrode 102 and the sample stage 104 to the shield (the protection silica plate 123) or the wall of the heat treatment chamber 100 is secured at 30 mm or more. It is advantageous to suppress heat dissipation when the heat transfer distance of a gas is longer. However, when the heat transfer distance of a gas is too long, the size of the heat treatment chamber 100 with respect to the heating regions is increased, which is not preferable. The heat transfer distance of a gas is set to 30 mm or more, and heat dissipation caused by heat transfer from the gas atmosphere can also be suppressed while suppressing the size of the heat treatment chamber 100. Needless to say, of course, Ar, Xe, Kr gas or the like of a low thermal conductivity coefficient is used to further suppress heat dissipation caused by heat transfer from the gas atmosphere.

In this embodiment, a radio frequency power supply at a frequency of 13.56 MHz is used for the radio frequency power supply 111 for generating plasma. This is because a a radio frequency power supply can be obtained at low cost as a frequency of 13.56 MHz is an industrial frequency and apparatus cost can be reduced as the standard for electromagnetic wave leakage is not so severe. However, needless to say, heat treatment can be theoretically performed in the similar principle at other frequencies. Particularly, frequencies of 1 to 100 MHz are preferable. A radio frequency voltage in supplying power necessary for heat treatment is increased at frequencies below a frequency of 1 MHz, which causes faulty electric discharge (unstable plasma and electric discharge at a location other than a location between the upper electrode and the lower electrode) to make it difficult to generate stable plasma. Moreover, the impedance of the gap 108 between the upper electrode 102 and the lower electrode 103 is low at a frequency exceeding a frequency of 100 MHz, and a voltage necessary to generate plasma does not tend to be obtained, which is not desirable.

Next, the position of the gas introducing nozzle 131 after finishing preheating will be described. After finishing preheating, the gas introducing nozzle 131 is brought away from the upper electrode 102, and retracted to near the side surface of the heat treatment chamber 100. Thus, it is possible to prevent the ununiformity of heating and the faulty electric discharge between the gas introducing nozzle 131 and the upper electrode 102 or the lower electrode 103 in the subsequent high temperature heat treatment.

When the plasma heat treatment apparatus illustrated in FIG. 1 is used to preheat the graphite electrodes and heat the sample according to the flow illustrated in FIG. 4, the attachment of soot to the surface of the reflecting mirror for the purpose of heating efficiency improvement, a reduction in the reflectance of the reflecting mirror, a reduction in the reproducibility of processing temperature, an increase in electric power necessary for implementing a desired temperature, and the like are not confirmed, and the degradation of thermal efficiency and variations in thermal efficiency are suppressed for a long time. Moreover, unstable electric discharge is also not observed.

As described above, according to this embodiment, the upper electrode and the lower electrode are preheated to provide a method and apparatus for plasma heat treatment that can suppress the degradation of thermal efficiency even in the case where plasma is used to heat a sample at a temperature of 1,200° C. or more.

### Second Embodiment

A second embodiment of the present invention will be described with reference to FIG. 6. It is noted that points described in the first embodiment and not described in this embodiment are also applicable to this embodiment unless otherwise specified. FIG. 6 is a process sequence for describing the process step of preheating graphite electrodes in a plasma heat treatment method according to this embodiment.

A difference between the process sequence illustrated in FIG. 6 and the process sequence of the first embodiment illustrated in FIG. 5 is in that a processing pressure is changed. The basic configuration of a plasma heat treatment apparatus used in this embodiment is the same as the plasma heat treatment apparatus of the first embodiment in FIG. 1, so that the description will be made with reference to FIGS. 1 and 6. First, as similar to the first embodiment, He gas in a heat treatment chamber 100 is exhausted from an air outlet port 115 to provide a high vacuum state. In the stage in which the gas exhaust is sufficiently finished, gas is introduced from a gas introducing unit 113, and the inside of the heat treatment chamber 100 is controlled at a pressure of 0.1 atmosphere. In this embodiment, He is used for gas introduced into the heat treatment chamber 100. At a point in time when a gas pressure in the heat treatment chamber 100 is stabilized, radio frequency power from a radio frequency power supply 111 is supplied to an upper electrode 102 through a matching circuit 112 and a power introducing terminal 119 (at time t_{A1}), and plasma is generated in a gap 108 to heat the upper electrode 102 and a lower electrode 103. Subsequently, the flow rate of supplied gas is reduced at time t_{A2} to decrease the processing pressure. As a result, impurity gases released from the electrodes are discharged out of the heat treatment chamber 100 in association with a reduction in the pressure. On the other hand, when the gas flow rate is kept reduced and the gas pressure reaches near a vacuum, an electric discharge maintaining voltage is increased by Paschen's law, causing the difficulty to maintain electric discharge. Therefore, He gas is again introduced from a gas introducing nozzle 131 to increase the gas pressure (at time t_{A3}). In this embodiment, He gas is introduced at a point in time when the gas pressure is reduced to a pressure of 0.01 atmosphere, and the gas pressure is increased to a pressure of 0.1 atmosphere. After this increase, the gas flow rate of He gas is reduced, the processing pressure is again decreased to exhaust the emitted impurity gases, and He gas is again supplied at time t_{A4}. The supply value of He gas is controlled to repeat an increase and a reduction of the pressure in the heat treatment chamber 100, and the impurity gases can be effectively exhausted. It is possible to reliably exhaust the impurity gas according to this method even in the case where gas is not sufficiently exchanged between the upper electrode 102 and the lower electrode 103.

It is likely that a slight soot is generated in performing subsequent processing like this. Therefore, gas at a large flow rate is fed for a certain period of time at time t_{An}, and a state of a large gas flow is generated in the heating chamber. This gas flow can forcedly remove soot attached in the heating chamber or floating soot. The gas flow rate is again reduced at time t_{B1} to perform a preheating process intended to remove impurity gas in the stage in which the impurity gas grow soot. It is made possible to remove impurity gas and soot by performing this preheating. It is noted that a method for controlling the gas supply value is not limited to the method in FIG. 6. For example, a gas at a large flow rate may be supplied beforehand at an individual point in time when the temperature of the electrodes is increased. Moreover, the processing described above is performed by a control unit, not illustrated.

In this embodiment, the gas pressure is changed between a pressure of 0.1 atmosphere and a pressure of 0.01 atmosphere. However, no problem arises when the gas pressure is increased to a pressure of 10 atmospheres. However, as similar to the first embodiment, the gas pressure ranging from a pressure of 0.01 atmosphere to a pressure of 0.1 atmosphere is preferable. Moreover, in this embodiment, the gas flow rate is changed to control the gas pressure. However, the similar effect can also be obtained in which the gas displacement is changed to adjust the gas pressure. It is noted that of course, the gas flow rate and the gas displacement may be changed simultaneously to control the pressure.

In this embodiment, the timing of increasing the gas pressure and the timing of reducing the gas pressure are controlled by monitoring the gas pressure in the heat treatment chamber 100. Preferably, this cycle is made shorter than the time for which unstable electric discharge or soot clusters are generated between the upper electrode 102 and the lower electrode 103 due to impurity gas.

In this embodiment, processing is performed at a constant output of the radio frequency power. However, the output of the radio frequency power may be changed according to fluctuations in the gas pressure.

In this embodiment, He gas is used for the raw material gas for generating plasma. However, needless to say, the similar effect can also be exerted when gas having inert gas such as Ar, Xe, and Kr as a main raw material is used. He gas used in this embodiment is excellent in the ignitability and stability of plasma near an atmospheric pressure. However, the gas thermal conductivity coefficient is high, and a heat loss is relatively large due to heat transfer through the gas atmosphere. On the other hand, since gas with a large mass such as Ar, Xe, and Kr gas has a low thermal conductivity coefficient, these gases are more advantageous than He gas from the viewpoint of thermal efficiency.

When the plasma heat treatment apparatus illustrated in FIG. 1 is used to preheat the graphite electrodes and heat the sample according to the flow illustrated in FIG. 4, the attachment of soot to the surface of the reflecting mirror for the purpose of heating efficiency improvement, a reduction in the reflectance of the reflecting mirror, a reduction in the reproducibility of processing temperature, an increase in electric power necessary for implementing a desired temperature, and the like are not confirmed, and variations in thermal efficiency are suppressed for a long time. Moreover, unstable electric discharge is also not confirmed.

As described above, according to this embodiment, the upper electrode and the lower electrode are preheated to provide a method and apparatus for plasma heat treatment that can suppress the degradation of thermal efficiency even in the case where plasma is used to heat a sample at a temperature of 1,200° C. or more. Furthermore, it is possible that the gas pressure or the gas flow rate is changed to effectively discharge soot in preheating the upper electrode and the lower electrode.

It is noted that the present invention is not limited to the foregoing embodiments, and the present invention includes various exemplary modifications and alterations. For example, the embodiments describe the present invention in detail for easy understanding, and the embodiments are not necessarily limited to ones including all the configurations described above. Moreover, a part of the configuration of one embodiment can be replaced by the configuration of another embodiment, and the configuration of one embodiment can be added with the configuration of another embodiment. Furthermore, a part of the configuration of the individual embodiments can be added with the other configurations, can be deleted, and can be replaced by the other configurations.

What is claimed is:

1. A method for plasma heat treatment using an apparatus for plasma heat treatment including a heat treatment chamber in which plasma generated between an upper electrode and a lower electrode heats a sample to be processed, the method comprising the steps of:
preheating in which the heat treatment chamber is exhausted while preheating the upper electrode and the lower electrode using plasma generated between the upper electrode and the lower electrode; and
heat treatment in which the sample to be processed is heated after the preheating step,
wherein the upper electrode and the lower electrode are electrodes containing carbon.

2. The method for plasma heat treatment according to claim 1,
wherein the plasma is generated in the preheating step while supplying gas into the heat treatment chamber.

3. The method for plasma heat treatment according to claim 2,
wherein the gas is noble gas.

4. The method for plasma heat treatment according to claim 1,
wherein the heat treatment step is the step of indirectly heating the sample to be processed with the lower electrode heated by the plasma.

5. The method for plasma heat treatment according to claim 1,
wherein the sample to be processed is loaded into the heat treatment chamber and the heat treatment step is performed after finishing the preheating step.

6. The method for plasma heat treatment according to claim 1,
wherein the preheating step is performed at temperature in a range of temperatures of 700 to 1,000° C.

7. The method for plasma heat treatment according to claim 1,
wherein plasma in the preheating step is generated by glow discharge.

8. The method for plasma heat treatment according to claim 2,
wherein the preheating step is performed while changing a flow rate of the gas.

9. The method for plasma heat treatment according to claim 2,
wherein the preheating step is performed while changing a pressure in the heat treatment chamber.

10. The method for plasma heat treatment according to claim 2,
wherein the heat treatment step is performed in a state in which the heat treatment chamber is sealed.

11. An apparatus for plasma heat treatment comprising:
a heat treatment chamber;
a reflecting mirror disposed in the heat treatment chamber;
a graphite upper electrode and a graphite lower electrode disposed on an inner side of the reflecting mirror;
a sample stage disposed below the lower electrode and configured to hold a sample to be processed;
a radio frequency power supply configured to generate plasma between the upper electrode and the lower electrode;
a gas introducing unit configured to introduce gas between the upper electrode and the lower electrode;
an exhausting unit configured to exhaust the heat treatment chamber; and
a preheating function to exhaust the heat treatment chamber while preheating the upper electrode and the lower electrode using plasma generated between the upper electrode and the lower electrode before heating the sample to be processed.

12. The apparatus for plasma heat treatment according to claim 11,
wherein a member in a cylindrical inner shape to cover a side wall of the sample to be processed held on the sample stage is provided below the lower electrode.

13. The apparatus for plasma heat treatment according to claim 11, wherein:
the gas introducing unit is movable; and
a gas introducing tip end of the gas introducing unit is disposed at height between the upper electrode and the lower electrode in preheating.
